(19) United States
(12) Patent Application Publication
(10) Pub. No.: US 2016/0201728 A1
(43) Pub. Date: Jul. 14, 2016

(54) STEERING SHAFT FOR A MOTOR VEHICLE STEERING SYSTEM

(71) Applicants: THYSSENKRUPP PRESTA AG, Eschen (LI); THYSSENKRUPP AG, Essen (DE)

(72) Inventors: Joseph-Léon STROBEL, Mauren (LI); Eugen LASS, Heerbrugg (CH); Patrick RENGGLI, Zürich (CH); Peter KNOLL, Lindau (DE); Ueli SCHLEGEL, Fläsch (CH)

(73) Assignees: THYSSENKRUPP PRESTA AG, Eschen (LI); THYSSENKRUPP AG, Essen (DE)

(21) Appl. No.: 14/914,545

(22) PCT Filed: Aug. 8, 2014
(86) PCT No.: PCT/EP2014/002180

§ 371 Date: Feb. 25, 2016

(30) Foreign Application Priority Data
Aug. 27, 2013 (DE) 10 2013 109 284.5

(51) Int. Cl. F16D 1/02

(52) U.S. Cl. CPC F16D 1/02

(57) ABSTRACT

An example steering shaft for a motor vehicle steering system for use with a power assistance system may include an input shaft, an output shaft, and a torsion bar. The torsion bar may connect the input and output shafts in a torsionally elastic manner for purposes of transmitting a torque, in many cases from the input shaft to the output shaft. In particular, a joining section of the torsion bar may be connected to a joining socket of one or more of the input shaft or the output shaft. The joining section may include partial elevations for forming a nonpositive and positive connection to the joining socket.

### TECHNICAL FIELD

The present invention relates to a steering shaft for a motor vehicle steering system for use with a power assistance system, said shaft comprising an input shaft and an output shaft, which are connected to one another in a torsionally elastic manner by means of a torsion bar in order to transmit a torque, wherein a joining section of the torsion bar is connected to a joining socket of the input shaft and/or the output shaft.

### PRIOR ART

In the field of steering shafts for motor vehicle steering systems, it is a known practice to determine a torque input via an input shaft relative to an output shaft and, on this basis, to apply an auxiliary torque to the steering shaft by means of a power assistance system to assist the driver with steering. For this purpose, it is a known practice, in the case of power-assisted vehicle steering systems, to subdivide the steering shaft of the motor vehicle into an input shaft and an output shaft, wherein the input shaft is generally connected to the steering wheel of the motor vehicle, by means of which a driver introduces the corresponding steering torque or corresponding steering command into the input shaft. The output shaft is generally connected to the steering pinion, which transmits the steering movement to the steered wheels of the motor vehicle via a corresponding rack and track rods.

Power assistance systems, e.g. electric power assistance systems or hydraulic power assistance systems, are generally attached to the output shaft, to the steering pinion or to the rack in order to introduce the corresponding auxiliary torques. In this case, the respective power assistance system is controlled by determining the torque, relative to the output shaft, introduced into the input shaft via the steering wheel by the driver.

At the same time, there is a known practice of connecting the input shaft and the output shaft of a steering shaft by means of a torsion bar and determining the input torque from the relative angle of twist between the input shaft and the output shaft by means of a torque sensor. In a hydraulic servo steering system, this can take place by means of a rotary slide valve, for example, while, in the case of an electric servo steering system, it can take place by means of corresponding magnetic sensors, for example.

In order to prevent overloading of the torsion bar, the input shaft and the output shaft can be connected to one another by loose positive engagement, such that there is direct positive engagement of the input shaft with the output shaft when a maximum value for the elastic twisting of the torsion bar is exceeded.

Torsionally secure connection of the torsion bar to the input shaft and/or the output shaft is important for the functioning of the corresponding torsionally elastic connection between the input shaft and the output shaft, which ultimately enables the torque to be sensed. For this purpose, the torsion bar is generally pressed into frictional engagement with the input shaft and/or the output shaft.

During assembly, it must then be taken into account that a torsion bar is generally prone to buckling and, accordingly, the torsion bar must be pressed into a joining socket of the input shaft and/or the output shaft in such a way that buckling of the torsion bar is prevented.

For this purpose WO 2006/048392 proposes to provide one end of the torsion bar with toothing, for example, such that this toothing can dig into the corresponding joining socket in the output shaft.

DE 10 2011 054 983 A1 proposes to provide two rolling bearings which roll directly on the circumferential surface of the torsion bar and which allow the torsion bar to be centered and guided during the process of pressure application. Here, the torsion bar has splines at one end, which are held under pressure in the closed cylindrical internal profile of the respective steering spindle.

### DESCRIPTION OF THE INVENTION

Starting from the known prior art, it is an object of the present invention to specify a steering shaft which allows a further improvement in the connection of the torsion bar to a shaft.

This object is achieved by a steering shaft having the features of claim 1. Advantageous developments can be found in the dependent claims.

Accordingly, a steering shaft for a motor vehicle steering system for use with a power assistance system is proposed, said shaft comprising an input shaft and an output shaft, which are connected to one another in a torsionally elastic manner by means of a torsion bar in order to transmit a torque, wherein a joining section of the torsion bar is connected to a joining socket of the input shaft and/or the output shaft, in which the joining section of the torsion bar has partial elevations for forming a nonpositive and positive connection to the joining socket (40, 42) of the input shaft (10) and/or the output shaft (12).

By providing the joining section on the torsion bar in such a way that partial elevations are provided in the joining section to form a nonpositive and positive connection to the input shaft and/or the output shaft, simple joining of the joining section of the torsion bar and the joining socket of the respective input and/or output shaft can be achieved, resulting in a sufficiently torsionally rigid connection of the torsion bar and the input shaft and/or output shaft.

In one embodiment of the invention, the joining sockets of the input shaft and/or of the output shaft are of cylindrical design.

The connection between the torsion bar and the input shaft and output shaft is preferably accomplished exclusively by means of the surfaces formed in the joining sections of the torsion bar and the joining socket of the input shaft and the joining socket of the output shaft without the use of further components, such as retention pins, as connecting means. As another preferred option, the connection between the torsion bar and the input shaft and output shaft is accomplished without the use of adhesives, cements or separate adhesion agents.

In the simplest case, the partial elevations can be formed by a thread, which can even be produced as a cut thread. However, the partial elevations of the joining section are preferably obtained by displacement of material, particularly preferably by forming without cutting, e.g. by roller forming, knurling and/or embossing.

The use of partial elevations in the joining section which are obtained by displacement of material makes it unnecessary to machine the joining section. On the contrary, the corresponding working of the joining section means that the torsion bar can simply be pressed into the joining socket by means of its respective joining section and that the press-in forces that have correspondingly to be applied are far below the critical buckling force for the torsion bar. This also makes it possible to produce a press fit at both ends of the torsion bar, namely both in relation to the joining socket of the input shaft and in relation to the joining socket of the output shaft. It is thus possible to dispense with expensive machining steps for the production of the joining socket and of the respective joining section of the torsion bar.

In a preferred development, the partial elevations are designed as continuous beads and/or rings, as a continuous thread or as ribs extending continuously along the joining section in the press-in direction. By means of said configurations of continuous partial elevations, it is possible to create a connection which is independent of the respective position of the torsion bar relative to the output shaft and/or the input shaft during joining, which can be joined together in any rotational orientation and which then provides a torsionally rigid connection in this joined rotational orientation. This is particularly advantageous if the input shaft is supposed to be connected to the output shaft in a predetermined position of alignment by means of the torsion bar.

As a particularly preferred option, the joining socket of the input shaft and/or output shaft likewise has partial elevations. During the joining of the joining section which has partial elevations to the joining socket of the input shaft and/or of the output shaft, which likewise has partial elevations, the required press-in forces can be further reduced. However, the possibility of flow of the material, especially in the region of the respective partial elevations, means that not only nonpositive engagement but also improved positive engagement, which leads to a correspondingly torsionally rigid connection, is produced during this process.

It is to be particularly preferred here if the basic shape of the joining socket is cylindrical and the partial elevations are introduced into the cylindrical surface. In this case, the partial elevations are enclosed to a limited extent by two enveloping surfaces, which are each preferably of cylindrical design. In other words, the enveloping surfaces of the partial elevations in the surface and the correspondingly partially formed depressions in the surface are each preferably of cylindrical design.

In this case, positive engagement takes place at least in a plane which is perpendicular to the press-in direction. Good torsional rigidity of the joined parts is thereby obtained.

In the simplest case, the partial elevations can be formed by a thread, which can even be produced as a cut thread. However, the partial elevations of the joining socket are also preferably obtained by displacement of material and are preferably formed by forming without cutting, particularly preferably by roller forming, knurling and/or embossing. It is thereby once again possible to avoid expensive cutting methods.

The alignments of the elevations, obtained by deformation of material, in the joining socket of the respective input and/or output shaft and of the joining section of the torsion bar preferably differ. In this case, the partial elevations of the torsion bar preferably extend at an angle to the partial elevations in the joining socket, and particularly preferably extend substantially perpendicularly thereto.

In an illustrative but not restrictive embodiment, the alignment of the elevations is substantially perpendicular to one another. Accordingly, the angular range of the elevations aligned “substantially perpendicularly” to one another is from 85° to 95°. The angle can be in a range of +/−10°, particularly preferably in a range of +/−5°.

For example, the partial elevations in the joining socket can be formed by encircling beads or a thread, and the partial elevations in the joining section of the torsion bar extend as ribs in an axial direction or in the press-in direction of the torsion bar, for example. In an alternative embodiment, the partial elevations in the joining socket can be formed axially, i.e. can extend in the press-in direction, and the partial elevations in the joining section of the torsion bar can extend in a circumferential direction or form a thread.

In the configurations mentioned, there is particularly advantageously a reduction in the necessary press-in forces, while, at the same time, a reliable positive and frictional connection is formed in the joining process. In this way, the torsion bar can be joined to the input shaft and/or output shaft under pressure in a torsionally rigid manner without exceeding the buckling force for the torsion bar.

In a particularly preferred configuration, both the input shaft and the output shaft are configured in such a way that the respective joining socket of the input shaft and the joining socket of the output shaft have a partial elevation obtained by displacement of material, such that the torsion bar can be connected by means of the respective joining sections thereof, that is to say, in particular, the joining sections arranged at each end of the torsion bar, to form a nonpositive and positive connection, wherein the necessary press-in forces or joining forces do not exceed or fall significantly below the buckling force of the torsion bar in the case of both connections.

The press-in force can preferably be reduced to values in a range of less than 3000 newtons, thus ensuring that the buckling force potentially acting on the torsion bar is undershot by a large amount during the actual assembly of the device for transmitting a torque.

As a particularly preferred option, the partial elevations, obtained by displacement of material, in the joining socket and on the joining section of the torsion bar are applied by embossing, knurling or roller forming in such a way that the material of the torsion bar or the material of the respective input and/or output shaft flows in the region of the joining socket and is accordingly displaced in such a way that the corresponding elevations are formed. This is achieved, in particular, by forming without cutting, e.g. the knurling, roller forming or embossing mentioned.

In the joining socket, partial elevations obtained by displacement of material lead to a partial reduction in the diameter of the joining socket in the region of the elevations extending in the joining socket, but they also lead to a partial increase in the diameter of the joining socket in the regions of the displaced material relative to the original dimensions, e.g. of a joining socket formed as a bore for receiving the torsion bar. Similarly, there is a partial enlargement of the torsion bar at the joining section relative to the diameter thereof in the region of the elevations through the application of the partial elevations obtained by displacement of material, and there is simultaneously also a partial reduction in the diameter relative to the initial diameter in the regions of the displaced material. By virtue of the corresponding structuring of the joining socket and of the joining section, it is in this way possible to ensure that flow of the material is in turn possible during the subsequent exertion of pressure on the joining section in the joining socket, such that, on the one hand, there is nonpositive engagement under pressure but, on the other hand, positive engagement is also produced by virtue of the flow of the material, said positive engagement leading, in particular, to the achievement not only of a safeguard against pulling out but also of a torsionally rigid connection between the torsion bar and the input shaft and/or the output shaft.

Whether the flow of the material takes place primarily in the joining section of the torsion bar or in the joining socket of the input or output shaft or in both equally depends on the relative hardness of the respective materials. However, it is envisaged that the flow of the material due to the fitting of the torsion bar into the input shaft and/or the output shaft will take place only in the regions of the partial elevations of the material of the respective joining section and of the respective joining socket. In the preferred case that the partial material elevations are formed by pure forming, the flow of the material for indentation takes place only in the regions of the material which have previously been affected by the pure forming operation. It is not envisaged that the material elevations will be fitted, in particular dug, into the base material of the joining socket by means of a cutting or forming process. Here, the boundary of the base material is formed by the enveloping surface delimiting the material elevations, which has the larger diameter.

The initial dimensions of the bore of the joining socket in respect of the joining section of the torsion bar can be selected in such a way that the joining socket has a somewhat larger diameter than would be provided in the case of an interference fit, for example, which would be provided without the partial elevations obtained by displacement of material. Nevertheless, a torsionally rigid connection can be achieved through the interaction of the partial elevations of the joining section and of the joining socket. However, the press-in forces required for this purpose are significantly lower by virtue of the different dimensions.

In another preferred embodiment, the torsion bar has a smooth centering section, which adjoins the joining section, preferably directly adjoins said section. By means of the centering section, assembly can be further simplified since, in particular, rotational alignment of the input shaft relative to the output shaft can be performed in a pre-assembly position and a complete connection is performed only after the predetermined rotational position has been adopted.

At its end facing the input shaft, the torsion bar particularly preferably has a joining section with partial elevations to form a nonpositive and positive connection with the joining socket of the input shaft, and, at its end facing the output shaft, said torsion bar has a joining section with partial elevations to form a nonpositive and positive connection with the joining socket of the output shaft. In other words, a joining section is preferably provided at both ends of the torsion bar. In this way, the advantages of the joining process described can be exploited for both ends of the torsion bar.

In order to avoid exceeding a maximum torsional loading of the torsion bar and of the connection of the torsion bar to the input shaft and the output shaft, the input shaft is preferably additionally connected to the output shaft by loose positive engagement.

### BRIEF DESCRIPTION OF THE FIGURES

Preferred further embodiments and aspects of the present invention are explained in greater detail by the following description of the figures, of which:

FIG. 1 shows a schematic illustration of a motor vehicle steering system having a power assistance system;

FIG. 2 shows a schematic perspective illustration of a steering shaft;

FIG. 3 shows a schematic perspective exploded illustration of the steering shaft in FIG. 2;

FIG. 4 shows another schematic perspective illustration of the steering shaft in FIGS. 2 and 3 in an intermediate assembly state;

FIG. 5 shows a schematic cross-sectional view through sections of the steering shaft in FIGS. 2 to 4 in the assembled state;

FIGS. 6 to 8 show schematic cross-sectional views through different embodiments of a joining socket;

FIGS. 9 and 10 show schematic perspective illustrations of the joining sections formed at one end and at the other end of the torsion bar;

FIG. 11 shows a schematic sectional view of a torsion bar of another embodiment;

FIGS. 12 and 13 show schematic illustrations of further configurations of the joining section;

FIG. 14 shows a schematic cross-sectional view of a joining socket in another embodiment;

FIG. 15 shows a schematic sectional view of a torsion bar in yet another embodiment;

FIG. 16 shows a schematic perspective illustration of a steering shaft in another embodiment; and

FIGS. 17 and 18 show schematic illustrations of a steering shaft with loose positive engagement between an input shaft and an output shaft.

### DETAILED DESCRIPTION OF PREFERRED EMBODIMENTS

Preferred embodiments are described below by means of the figures. Here, elements which are identical, similar or have the same action are denoted by identical reference signs in the various figures and, in some cases, repeated description of these elements is avoided in the following description in order to avoid duplication.

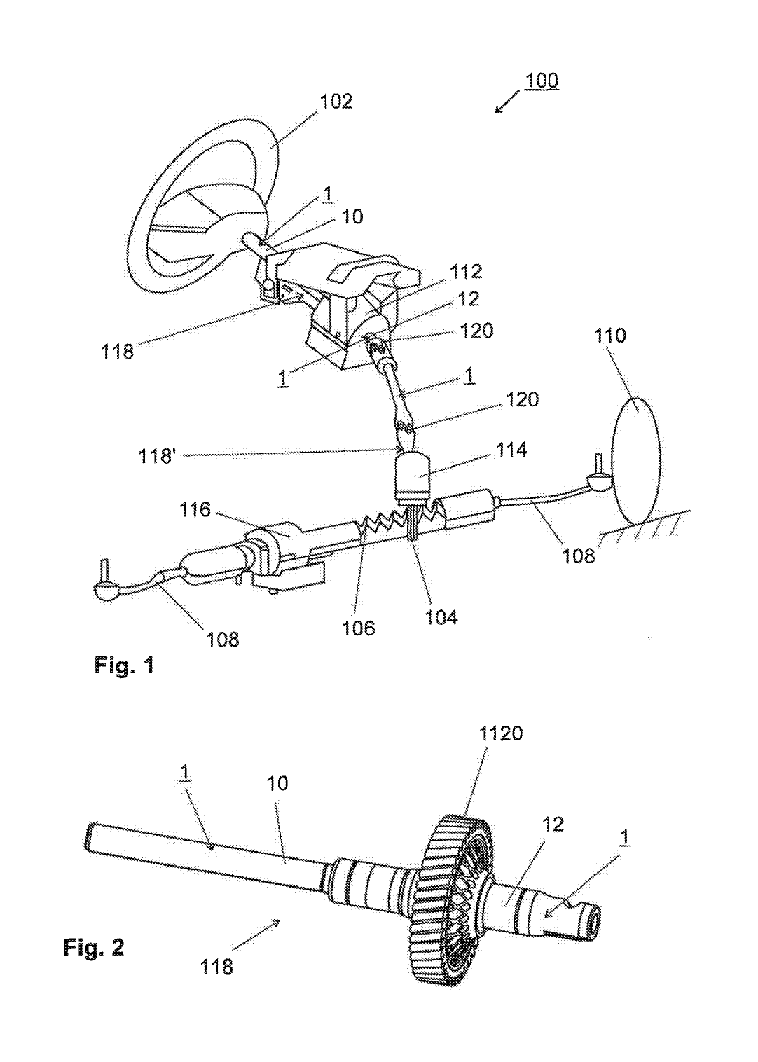

FIG. 1 shows a schematic illustration of a motor vehicle steering system 100, wherein a driver introduces a corresponding torque as a steering command into a steering shaft 1 via a steering wheel 102. The torque is then transmitted via the steering shaft 1 to a steering pinion 104, which meshes with a rack 106, which, for its part, then transmits the specified steering angle to the steerable wheels 110 of the motor vehicle via corresponding track rods 108.

An electric and/or hydraulic power assistance system in the form of power assistance system 112, or alternatively also power assistance system 114 or 116, can be coupled either to the steering shaft 1, the pinion 104 or the rack 106. The respective power assistance system 112, 114 or 116 introduces an auxiliary torque into the steering shaft 1 or the steering pinion 104 and/or an auxiliary force into the rack 106, thereby assisting the driver with the steering work. The three different power assistance systems 112, 114 and 116 illustrated in FIG. 1 show alternative positions for the arrangement thereof. Normally, only one of the positions shown is occupied by a power assistance system. The auxiliary torque or the auxiliary force which is to be applied by means of the respective power assistance system 112, 114 or 116 to assist the driver is determined while taking into account the input torque determined by the torque sensor 118. As an alternative or in combination with the introduction of the auxiliary torque or auxiliary force, an additional steering angle can be introduced into the steering system by means of the power assistance system 112, 114, 116, said steering angle being added to the steering angle introduced into the steering wheel 102 by the driver.

The steering shaft 1 has an input shaft 10 connected to the steering wheel 102 and an output shaft 12 connected to the rack 106 by the steering pinion 104. The input shaft 10 and the output shaft 12 are coupled to one another in a torsionally elastic manner by a torsion bar. Thus, a torque introduced into the input shaft 10 by a driver via the steering wheel 102 always leads to rotation of the input shaft 10 relative to the output shaft 12 if the output shaft 12 does not rotate in exact synchronism with the input shaft 10. This relative rotation between the input shaft 10 and the output shaft 12 can be measured by means of a rotation angle sensor, for example, and can be correspondingly converted into a corresponding input torque relative to the output shaft on the basis of the known torsional stiffness of the torsion bar. In this way, the torque sensor 118 is formed by the determination of the relative rotation between the input shaft 10 and the output shaft 12. A torque sensor 118 of this kind is known in principle and can be implemented in the form of a rotary slide valve, by electromagnetic measurement of the relative rotation or by other measurements of the relative rotation, for example.

In this way, a torque applied to the steering shaft 1 or the input shaft 10 by the driver via the steering wheel 102 will only bring about the introduction of an auxiliary torque by one of the power assistance systems 112, 114, 116 if the output shaft 12 is rotated relative to the input shaft 10 against the torsional resistance of the torsion bar.

As an alternative, the torque sensor 118 can also be arranged at position 118′, in which case the division of the steering shaft 1 into input shaft 10 and output shaft 12 is correspondingly present at some other position in order to be able to determine a relative rotation from the relative rotation of the output shaft 12 coupled to the input shaft 10 by the torsion bar and hence correspondingly to be able to determine an input torque and/or an auxiliary force to be introduced.

The steering shaft 1 in FIG. 1 furthermore comprises at least one universal joint 120, by means of which the path of the steering shaft 1 in the motor vehicle can be matched to the spatial conditions.

The embodiments of the steering shaft 1 which are illustrated below in FIGS. 2 to 15 and 17 and 18 are particularly suitable for connection to the arrangement of the torque sensor 118 shown in FIG. 1 in conjunction with power assistance system 112.

The embodiment of the steering shaft 1 shown in FIG. 16 is particularly suitable for use together with the arrangement of the torque sensor 118′ in conjunction with power assistance system 114 or 116.

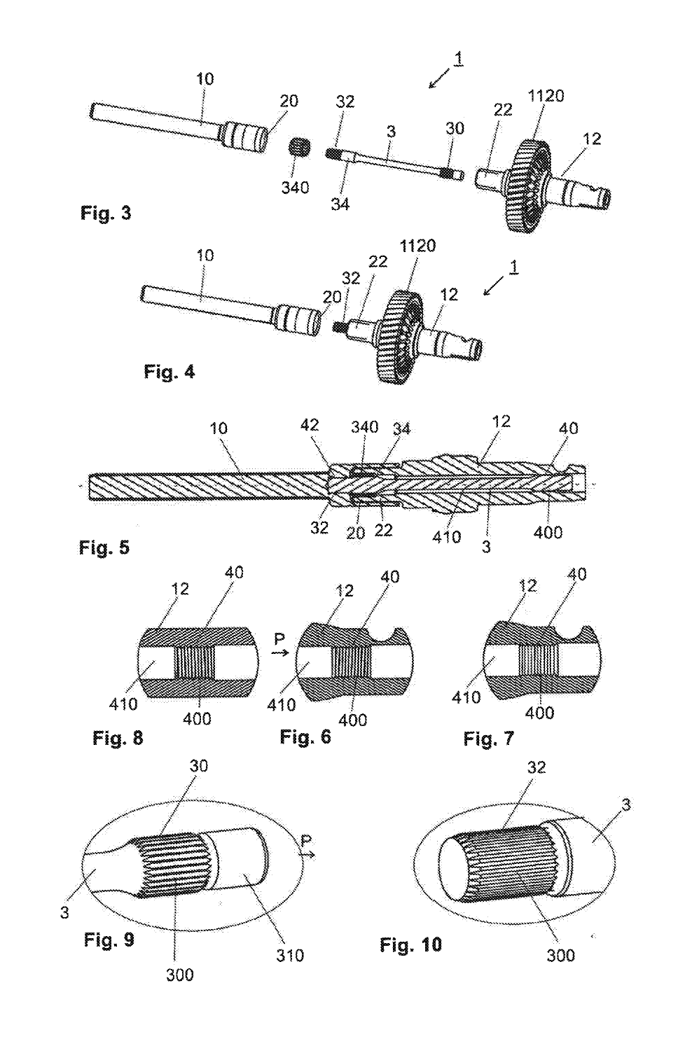

FIG. 2 shows schematically a steering shaft 1 having an input shaft 10 and an output shaft 12, wherein the region where the input shaft 10 and the output shaft 12 meet is spanned by the torque sensor 118 shown in FIG. 1. The input shaft 10 is connected to the output shaft 12 in a torsionally elastic manner by a torsion bar, which is not visible in FIG. 2 but extends internally, wherein the specific construction of the steering shaft 1 is illustrated in FIGS. 3 to 5.

To introduce the auxiliary torque by means of power assistance system 112, a worm wheel 1120 is provided for conjoint rotation on the output shaft 12. An output of an electric motor or servomotor of power assistance system 112 can act in an appropriate manner on the worm wheel 1120. In an alternative, it is also possible for a hydraulic drive to be provided. Power assistance system 112 accordingly serves to input the corresponding auxiliary torque for steering assistance to the driver into the output shaft 12 and hence into all the components of the motor vehicle steering system 100 which lie downstream of the output shaft 12.

To be able to precisely determine the corresponding torque or the amount of auxiliary force to be introduced via the worm wheel 1120, the input shaft 10 and the output shaft 12 are connected to one another in a torsionally elastic manner, as described above, with the result that the respective steering command which is input into the input shaft 10 via the steering wheel 102 by the driver results in corresponding assistance to the driver by power assistance system 112, which acts on the worm wheel 1120. For this purpose, the torque sensor 118 is provided, which determines the relative rotation between the input shaft 10 and the output shaft 12 or the corresponding relative angle of rotation between the input shaft 10 and the output shaft 12 and, on this basis, the auxiliary torque to be provided by the power assistance system 112 can be determined.

FIG. 3 shows a schematic exploded illustration of the steering shaft 1, wherein the input shaft 10 and the output shaft 12 are shown together with the worm wheel 1120.

The input shaft 10 has a bearing region 20, which serves to receive a shaft section 22, complementary thereto, of the output shaft 12. This is particularly clearly visible once again in the sectional illustration in FIG. 5, wherein the shaft section 22 of the output shaft 12 is introduced into the bearing region 20 of the input shaft 10, thus resulting in what is, in principle, freely rotatable mounting of the input shaft 10 on the output shaft 12.

A torsion bar 3 connects the input shaft 10 to the output shaft 12 in a torsionally elastic manner. This torsionally elastic connection of the input shaft 10 to the output shaft 12 is shown schematically in a sectional illustration in FIG. 5. For this purpose, the torsion bar has a joining section 30 at its end facing the output shaft 12 and a joining section 32 at its end facing the input shaft 10. The joining section 30 of the torsion bar 3 which faces the output shaft 12 is connected to the output shaft 12 in a torsionally rigid manner in a joining socket 40 of the output shaft 12. The joining section 32 of the torsion bar 3 which faces the input shaft 10 is connected to the input shaft 10 in a torsionally rigid manner in a joining socket 42 of the input shaft 10.

In the embodiment shown, the torsion bar 3 has a bearing region 34, on which a rolling bearing 340 can be mounted in such a way that, as can be seen, for example, from FIG. 5, the torsion bar 3 held in a torsionally rigid manner on the joining section 30 of the output shaft 12 can twist freely relative to the output shaft 12 in a through bore 410 of the output shaft 12, wherein the rolling bearing 340 rolls on the outside of the bearing section 34 of the torsion bar 3.

As can be seen from FIG. 5 for example, the joining socket 40 in the output shaft 12 has partial elevations 400 in the through bore 410 of the output shaft 12, said elevations being connected to the joining section 30 of the torsion bar 3. To form the connection, joining the torsion bar 3 to the output shaft 12 involves pressing the joining section 30 of the torsion bar 12 into the joining socket 40 of the output shaft 12.

As a particularly preferred option, the partial elevations 400 are produced by forming without cutting, preferably by displacement of material, e.g. by embossing, roller forming or knurling. When the respective elevation 400 extends in a circumferential direction, the partial elevations 400 are preferably formed as continuous beads or rings or as a continuous thread or continuous threads. When the elevations 400 extend in an axial direction, preferably in the press-in direction, they preferably extend continuously along the entire joining socket 40.

Further possible embodiments of the joining socket 40 are shown in FIGS. 6 to 8, wherein the joining socket 40 is provided in FIG. 6 with partial elevations 400 obtained by displacement of material, which are introduced in the form of a thread into the through bore 410 of the output shaft 12. These partial elevations 400 in the form of the thread, which are obtained by displacement of material, can be formed by embossing, knurling or roller forming, for example, such that forming without cutting is used to form the structure of the joining socket 40. The partial elevations 400 shown in FIG. 6, which are obtained by displacement of material, are formed substantially perpendicularly in a range of +/−10°, preferably in a range of +/−5°, to a press-in direction P.

An alternative design of the joining socket 40 or of the partial elevations 400 of the joining socket 40 in the through bore 410 of the output shaft 12, said elevations being obtained by displacement of material, is shown in FIG. 7, wherein the partial elevations 400 obtained by displacement of material here extend precisely in a circumferential direction of the through bore 410. In other words, these are beads or rings extending in a circumferential direction of the through bore 410, which are formed by displacement of material, i.e. without cutting, in the through bore 410.

In an alternative, the structure of the joining socket 40 can also be produced by cutting methods, e.g. by milling or broaching the joining socket 40.

By virtue of the partial elevations 400 obtained by displacement of material, there is a corresponding reduction in the inside diameter of the through bore 410 in the region of the joining socket 40, wherein the reduction in the inside diameter is produced at least by those regions of the elevations 400 which project into the through bore 410.

Yet another embodiment of a joining socket 40 is shown in FIG. 8, wherein the partial elevations 400 introduced in the through bore 410 are applied in thread form but with a different thread pitch and in a different region of the output shaft 12 than in the joining socket 40 in FIG. 6.

FIG. 4 shows schematically an assembled state of the steering shaft 1 in which the torsion bar 3 has already been fitted into the through bore 410 of the output shaft 12 and the joining section 30 of the torsion bar 3 is connected nonpositively and positively to the joining socket 40 of the output shaft 12. Accordingly, only the other joining section 32 of the torsion bar 3 is still projecting from the output shaft 12, thus allowing shaft section 22 of the output shaft 12 to be introduced into the corresponding bearing region 20 in a subsequent assembly step, whereby the joining section 32 of the torsion bar 3 is pressed into the corresponding joining socket 42 of the input shaft 10.

In FIG. 9, the joining section 30 of the torsion bar 3 is shown in a detailed view. The joining section 30 likewise has partial elevations 300, which come into contact with the partial elevations 400 of the joining socket 40 during joining and correspondingly cause flow of the material as they are pressed in, such that a nonpositive and positive connection is produced between the joining section 30 and the joining socket 40.

As a particularly preferred option, the partial elevations 300 are produced by forming without cutting, preferably by displacement of material, e.g. by embossing, roller forming or knurling. When the respective elevation 300 extends in a circumferential direction, the partial elevations 300 are preferably formed as continuous beads or rings or as a continuous thread or continuous threads. When the elevations 300 extend in an axial direction, preferably in the press-in direction, they preferably extend continuously along the entire joining socket 30.

In other words, elevations 300 dig into elevations 400 as the joining region 30 is pressed into the joining socket 40, with the result that a torsionally rigid connection is produced during joining while using a relatively low press-in force.

The partial elevations 300 of the joining section 30 of the torsion bar 3 which are obtained by displacement of material extend in press-in direction P, i.e. in the axial direction of the torsion bar 3. The partial elevations 300 of the joining section 30, which are obtained by displacement of material, are thus aligned substantially perpendicularly to the partial elevations 400 in the joining socket 40 of the output shaft 12, which are obtained by displacement of material. This substantially perpendicular alignment of the partial elevations 300 of the joining section, which are obtained by displacement of material, relative to the elevations 400 of the joining socket 40 also arises if a substantially thread-shaped structure of the partial elevations 400 is present in the joining socket 40.

By means of the elevations 300 and 400 extending at an angle, preferably at a substantially right angle, very good torsional rigidity can be achieved during the joining of the torsion bar 3 to the input shaft 10 and/or the output shaft 12. This is advantageous for the reliable functioning of the torsionally elastic connection of the input shaft 10 to the output shaft 12.

By means of the appropriate provision of the partial elevations 300 in the joining section 30 and of the partial elevations 400 in the joining socket 40 in such a way that the extent of the elevations 300, 400 is aligned at an angle and preferably substantially perpendicularly, in a range of +/−10°, preferably +/−5°, to one another, it is possible to produce positive engagement since corresponding rotation-inhibiting structures are created or remain in the direction of rotation or circumferential direction owing to corresponding flow of the material during the exertion of pressure.

FIG. 10 shows a design of the joining section 32 at the other end of the torsion bar 3, said joining section likewise having partial elevations 300, which are obtained by displacement of material and enter into connection with a corresponding formation of the joining socket 42 in the input shaft 10.

It is also possible to dispense with the rolling bearings 340 shown in FIGS. 3 and 5 since the necessary press-in force is so small, owing to the design of the joining section 32 and of the joining socket 42, that a possible buckling force of the torsion bar 3 is undershot by a large amount. It is thereby possible to achieve simple assembly and a simplification of the entire structure.

In order to prevent overloading of the torsion bar 3 or of the connection of the torsion bar 3 to the input shaft 10 and/or the output shaft 12 during the introduction of a high torque by means of the steering wheel, the input shaft 10 and the output shaft 12 are preferably connected to one another by loose positive engagement, in addition to the torsionally elastic connection via the torsion bar 3, in such a way that a maximum value for the rotation of the input shaft 10 relative to the output shaft 12 and hence also a maximum value for the twisting of the torsion bar 3 is predetermined.

During the assembly shown in FIG. 4, care must accordingly be taken to ensure that the torsion bar 3 is fitted in the central position of the loose positive engagement as regards the corresponding maximum angle of rotation. For this purpose, the parts are initially brought together with a clearance fit in a preferred embodiment, said clearance fit being formed, for example, by the introduction of a centering region 310 of the torsion bar 3 into the joining socket 30, said centering region being provided without the elevations 300. An aligned position is then found by turning both the input shaft 10 and the output shaft 10 as far as the end stops in both directions in order to determine the central position, thereby locating the center. Only after the central position has been found are the input shaft 12 and the output shaft 12 joined in this aligned position by simply being pressed together, and the torsion bar 3 forms its way into the corresponding joining socket 40 or 42 in this position, thus producing positive engagement and frictional engagement.

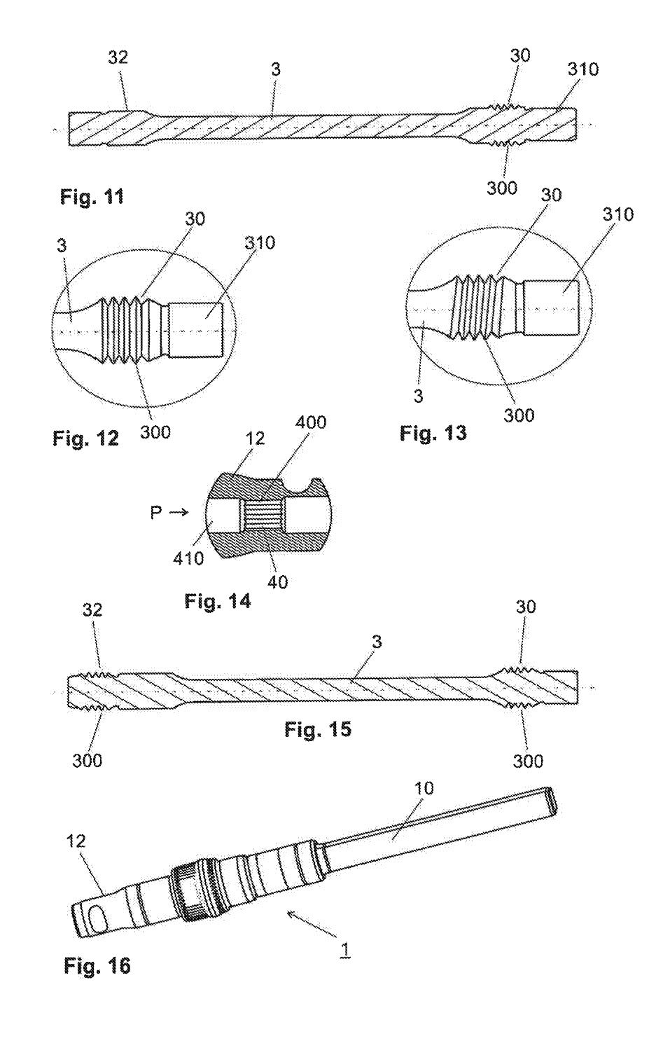

FIG. 11 shows a cross section through a torsion bar 3 in another embodiment. Partial elevations 300 obtained by displacement of material are provided in the joining section 30 of the torsion bar 3, said elevations extending in a circumferential direction of the torsion bar 3. This is also shown once again by way of example in FIGS. 12 and 13, wherein the joining section 30 in FIG. 12 is provided with partial elevations 300 obtained by displacement of material, said elevations extending exactly in a circumferential direction and, in this case, therefore being a multiplicity of continuous beads or rings situated adjacent to one another in an axial direction. In FIG. 13, the partial elevations 300 in the joining section 30, which are obtained by displacement of material, or are applied in the form of a thread.

FIG. 11 furthermore shows that the other joining section 32 of the torsion bar 3 is not provided with elevations, this being a cylindrical joining section 32, which produces a conventional interference fit during joining.

FIG. 14 shows a joining socket 40 in another embodiment, which interacts with the joining section 30 and in which partial elevations 400 obtained by displacement of material are provided, said elevations extending into the through bore 410 in the output shaft 12. These partial elevations 400 obtained by displacement of material extend in press-in direction P, i.e. in the axial direction of the through bore 410. Accordingly, the situation as the torsion bar 3 is fitted into the output shaft 12 is once again such that the partial elevations 300 extending in the joining section 30 extend at an angle and preferably substantially perpendicularly to the partial elevations 400 present in the joining socket 40. In this way, joining with a low pressing force is once again achieved, although good nonpositive engagement and good positive engagement is nevertheless achieved, giving a particularly torsionally rigid connection. Accordingly, the required press-in force can likewise be reduced, with the result that a buckling torque which may be introduced or a buckling force which may be introduced in the torsion bar 3 is below the critical buckling force and the torsion bar 3 is not damaged.

FIG. 15 shows a torsion bar 3 in another embodiment, wherein both joining section 30 is provided with partial elevations 300 obtained by displacement of material and the joining section 32 situated at the other end of the torsion bar 3 is provided with partial elevations 300 obtained by displacement of material, wherein the partial elevations 300 obtained by displacement of material each extend in a circumferential direction of the torsion bar 3 and accordingly can be configured either as encircling rings, beads or threads.

The corresponding forming process for producing the partial elevations 300 is preferably carried out by displacement of material, such as forming without cutting, e.g. embossing, knurling or rolling.

FIG. 16 shows a steering shaft 1 in another embodiment, which comprises an input shaft 10 and an output shaft 12 and which is provided for the purpose of being used together with the torque sensor 118′ in FIG. 1, for example. Accordingly, the steering pinion 104 is provided in a position directly adjoining the output shaft 12, and an auxiliary torque is applied directly to the steering pinion 104 by means of power assistance system 114 and/or directly to the rack 106 by means of power assistance system 116. The steering shaft 1 shown in FIG. 16 is of essentially the same construction internally as shown in the various embodiments in FIGS. 2 to 15.

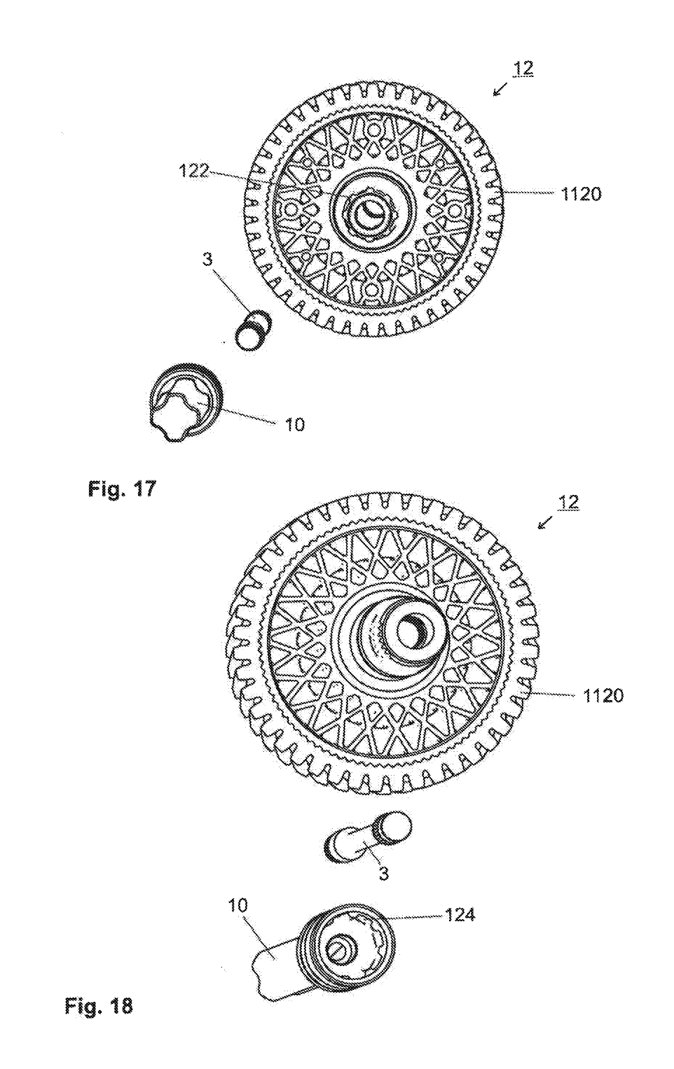

FIGS. 17 and 18 show schematically, in perspective illustrations, loose positive engagement between the input shaft 10 and the output shaft 12, which, in particular, has the worm wheel 1120. For this purpose, corresponding positive engagement elements 122 are provided on the output shaft 12, said elements corresponding to corresponding positive engagement sockets 124 on the input shaft 10. Here, the positive engagement sockets 124 on the input shaft 10 are of dimensionally larger design than the positive engagement elements 122, with the result that the positive engagement elements 122 on the output shaft 12 accordingly engage in the positive engagement sockets 124 of the input shaft 10 only with an angular play.

Accordingly, the torsion bar 3 can ensure torsionally elastic connection between the input shaft 10 and the output shaft 12. However, when a maximum rotation angle is exceeded, this being defined by the impact of a positive engagement socket 124 on a positive engagement element 122, transmission of an additional introduced torque takes place without further rotation of the input shaft 10 relative to the output shaft 12, with the result also that the auxiliary torque is not increased further.

In FIG. 18, the embodiment shown in FIG. 17 is shown in a schematic perspective view from a different direction. Here, the positive engagement sockets 124 which interact with the positive engagement elements 122 are particularly clearly visible.

Where applicable, all the individual features shown in the individual embodiments can be combined and/or interchanged with one another without exceeding the scope of the invention.

### LIST OF REFERENCE SIGNS

1 steering shaft

10 input shaft

12 output shaft

100 motor vehicle steering system

102 steering wheel

104 steering pinion

106 rack

108 track rod

110 steerable wheel

112 power assistance system

114 power assistance system

116 power assistance system

118 torque sensor

118′ torque sensor

120 universal joint

1120 worm wheel

122 positive engagement element

124 positive engagement socket

20 bearing region of the input shaft

22 shaft section of the output shaft

3 torsion bar

30 joining section

32 joining section

34 bearing region

300 partial elevations

310 centering region

340 rolling bearing

40 joining socket

42 joining socket

400 partial elevations

410 through bore

P press-in direction

1.-10. (canceled)

11. A steering shaft for a motor vehicle steering system for use with a power assistance system, the steering shaft comprising:
an input shaft;
an output shaft; and
a torsion bar for connecting the input shaft to the output shaft in a torsionally elastic manner for transmitting a torque, wherein a joining section of the torsion bar has partial elevations for forming a nonpositive and positive connection to a joining socket of at least one of the input shaft or the output shaft.

12. The steering shaft of claim 11 wherein the partial elevations of the joining section are formed not by cutting, but by displacement of material by at least one of roller forming, knurling, or embossing.

13. The steering shaft of claim 11 wherein the partial elevations of the joining section comprise at least one of continuous beads or rings as a continuous thread or as ribs extending continuously along the joining section in a direction in which the joining section is pressed into the joining socket.

14. The steering shaft of claim 11 wherein the joining socket comprises partial elevations.

15. The steering shaft of claim 14 wherein the partial elevations of the joining socket are formed not by cutting, but by displacement of material by at least one of roller forming, knurling, or embossing.

16. The steering shaft of claim 14 wherein the partial elevations of the joining section are substantially perpendicular to the partial elevations of the joining socket, within a range of ±10 degrees.

17. The steering shaft of claim 14 wherein the partial elevations of the joining socket comprise at least one of continuous beads or rings as a continuous thread or as ribs extending continuously along the joining section in a direction in which the joining section is pressed into the joining socket.

18. The steering shaft of claim 14 wherein the torsion bar comprises a smooth centering section that adjoins the joining section.

19. The steering shaft of claim 14 wherein the torsion bar comprises a smooth centering section that directly adjoins the joining section.

20. The steering shaft of claim 11 wherein a first end of the torsion bar facing the input shaft comprises a first joining section with partial elevations configured to form a nonpositive and positive connection with the joining socket of the input shaft, wherein a second end of the torsion bar facing the output shaft comprises a second joining section with partial elevations configured to form a nonpositive and positive connection with the joining socket of the output shaft.

21. The steering shaft of claim 11 wherein the input shaft is connected to the output shaft by loose positive engagement.
